(19) United States
(12) Patent Application Publication
(10) Pub. No.: US 2016/0072967 A1
(43) Pub. Date: Mar. 10, 2016

(54) INFORMATION PROCESSOR CREATING COMMUNICATION APPLICATION, AND COMPUTER-READABLE NON-TRANSITORY RECORDING MEDIUM STORING APPLICATION CREATION PROGRAM FOR CREATING COMMUNICATION APPLICATION

(71) Applicant: KYOCERA Document Solutions Inc., Osaka (JP)

(72) Inventor: Sachiko Yoshimura, Osaka (JP)

(73) Assignee: KYOCERA DOCUMENT SOLUTIONS INC., Osaka (JP)

(21) Appl. No.: 14/839,063

(22) Filed: Aug. 28, 2015

(30) Foreign Application Priority Data
Sep. 8, 2014 (JP) 2014-182661

(51) Int. Cl. H04N 1/00; G06F 3/12; H04L 29/08

(52) U.S. Cl. CPC H04N 1/00209; H04L 67/141; H04N 1/00244; G06F 3/1287; G06F 3/1288

(57) ABSTRACT

An information processor includes: an application information reception section, a function information reception section, a communication setting reception section, and an application creation section. The application information reception section receives an input of application information. The function information reception section receives an input of print settings as the function information from an operator. The communication setting reception section receives an input of communication settings, including an URL of a data storage server, required for the communication with the data storage serve. The application creation section creates, by using the application information, the communication application for executing processing in accordance with the print settings and the received communication settings.

### INCORPORATION BY REFERENCE

This application claims priority to Japanese Patent Application No. 2014-182661 filed on Sep. 8, 2014, the entire contents of which are incorporated by reference herein.

### BACKGROUND

This disclosure relates to an information processor creating a communication application, and a computer-readable non-transitory recording medium storing an application creation program for creating the communication application.

To add a function to the image processor or a mobile terminal, various applications which can be installed in these devices are under development. Then a technology that permits easier new application development has been suggested. Moreover, as a further technology for easier application development, application creation using an API (Application Programming Interface) has been carried out. The API is, for example, an interface (specifications which defines function retrieval procedures and a description method) which permits use of part of a function possessed by the application from an external application (for example, a program or a web service), and thus the use of the API by the developer no longer requires implementation of a program for performing this function in this application, permitting efficient application development.

### SUMMARY

As one aspect of this disclosure, a technology obtained by further improving the technology described above is to be suggested.

An information processor according to one aspect of this disclosure creates a communication application for connecting a client terminal via a network to a server providing a data storage service and causing data communication between the client terminal and the server. The information processor includes: an application information reception section, a function information reception section, a communication setting reception section, and an application creation section.

The application information reception section receives an input of application information accompanying the communication application;

The function information reception section receives an input of function information indicating a function included in predefined processing and performed on data targeted for communication with the server;

The communication setting reception section receives an input of communication settings, including an URL of the server, required for the communication with the server.

The application creation section creates, by using the application information received by the application information reception section, the communication application for executing, as part of a function, operation based on the function information received by the function information reception section and the communication settings received by the communication setting reception section.

A computer-readable non-transitory recording medium according to one aspect of this disclosure stores an application creation program for creating a communication application.

The application creation program creates a communication application for connecting a client terminal via a network to a server providing a data storage service and causing the client terminal to perform data communication with the server.

Moreover, the application creation program operates a computer as the application information reception section, the function information reception section, the communication setting reception section, and the application creation section.

### BRIEF DESCRIPTION OF THE DRAWINGS

FIG. 1 is a conceptual diagram showing how a data storage server on the web, an information processor, and an image forming apparatus are connected via the Internet;

FIG. 2 is a block diagram showing electrical configuration of the information processor;

FIG. 3 is a flowchart showing application creation processing performed by the information processor;

FIG. 4 is a diagram showing an application information setting reception screen;

FIG. 5 is a diagram showing a print setting reception screen;

FIG. 6 is a diagram showing an API setting reception screen;

FIG. 7 is a block diagram showing electrical configuration of the image forming apparatus;

FIG. 8 is a flowchart showing a series of processing of file downloading and printing performed by the image forming apparatus;

FIGS. 9A, 9B, and 9C are each one example of an operation screen;

FIG. 10 is a diagram showing a scan setting screen;

FIG. 11 is a diagram showing an API setting reception screen for scanning and uploading;

FIG. 12 is a flowchart showing a series of processing of scan operation performed in the image forming apparatus and uploading a file acquired by this scan operation; and

FIGS. 13A, 13B, 13C, and 13D are each one example of an operation screen.

### DETAILED DESCRIPTION

Hereinafter, an application creation program, a computer-readable non-transitory recording medium storing this application creation program, and an information processor according to an embodiment as one aspect of this disclosure will be described with reference to the drawings.

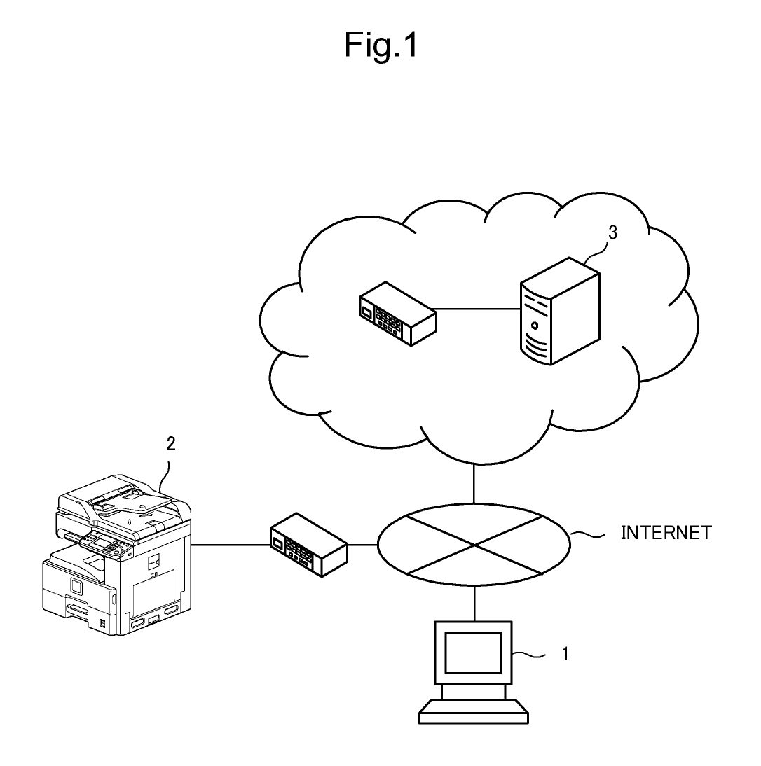

Hereinafter, the application creation program and the information processor according to one embodiment of this disclosure will be described with reference to the drawings. FIG. 1 is a conceptual diagram showing how a data storage server on the web, the information processor, and an image forming apparatus are connected via the Internet.

Via the Internet, the information processor 1, the image forming apparatus 2, and the server 3 providing a data storage service on the web (hereinafter referred to as data storage server) are connected.

The information processor 1, in accordance with an installed application creation program (to be described in detail later on), uses various pieces of information inputted from an operator (for example, a developer of a communication application) to create the communication application for data communication between the image forming apparatus 2 and the data storage server 3.

The data storage server 3 is a server that provides the data storage service on the web. The data storage server 3 provides the information processor 1 and the image forming apparatus 2 with various functions and data required for providing this data storage service. As a result, in the image forming apparatus 2, communication operation based on the installed communication application is executed by use of these functions and data provided.

For example, upon installation of this communication application, in accordance with this communication application, the image forming apparatus 2 connects to the data storage server 3, performs operation of communication with the data storage server 3 to achieve data transmission and reception, and performs printing of a file downloaded from the data storage server 3 or uploading of the file, which has been acquired through scan operation in the image forming apparatus 2, to the data storage server 3.

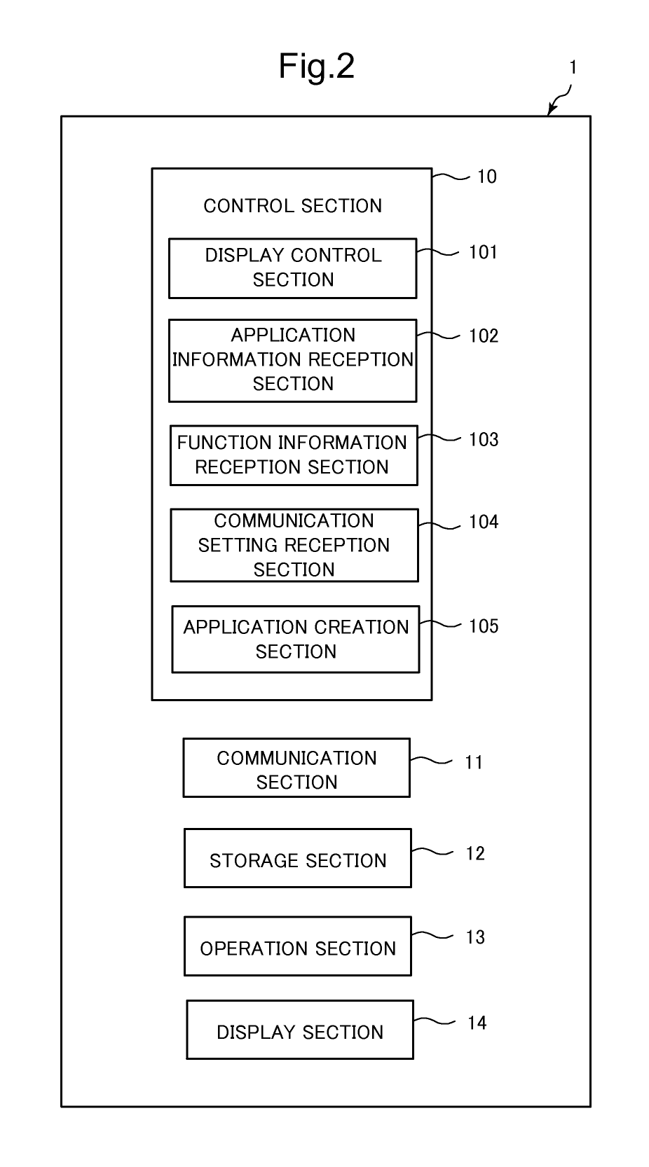

Next, electrical configuration of the information processor 1 will be described. FIG. 2 is a block diagram showing the electrical configuration of the information processor 1. The information processor 1 includes: a control section 10, a communication section 11, a storage section 12, an operation section 13, and a display section 14.

The communication section 11 is an interface that performs processing for communication via the Internet with, for example, the data storage server 3.

The storage section 12 is composed of, for example, an HDD (hard disc), in which the application creation program according to one embodiment of this disclosure is installed.

The operation section 13 is composed of, for example, a mouse pointer and a keyboard, and receives inputs of various operation instructions from the operator.

The display section 14 is composed of, for example, an LCD (liquid crystal display), and displays various images under control by a display control section 101.

The control section 10 is composed of: a CPU (Central Processing Unit), a RAM, a ROM, a dedicated hardware circuit, etc., and is responsible for overall operation control of the information processor 1. The control section 10 includes: the display control section 101, an application information reception section 102, a function information reception section 103, a communication setting reception section 104, and an application creation section 105. Stored in the storage section 12 is the application creation program according to one embodiment of this disclosure, in accordance with which the control section 10 operates to thereby function as the display control section 101, the application information reception section 102, the function information reception section 103, the communication setting reception section 104, and the application creation section 105 that perform processing required for application creation described below in this embodiment. Note that without depending on this application creation program, the control section 10 may include, as a hardware circuit, the display control section 101, the application information reception section 102, the function information reception section 103, the communication setting reception section 104, and the application creation section 105.

The display control section 101 controls display operation of the display section 14. For example, the display control section 101 makes the display section 14 display various operation screens (to be described later on) as a user interface at time of communication application creation processing according to the application creation program.

The application information reception section 102 receives, from the operator based on operation of the operation section 13, an input of application information as information accompanying the communication application created above.

The function information reception section 103 receives, from the operator based on operation of the operation section 13, an input of function information indicating functions, for example, print operation and scan operation, included in predefined operation performed on data targeted for communication with the data storage server 3.

The communication setting reception section 104 receives, from the operator based on operation of the operation section 13, an input of communication settings (including URL of the data storage server 3) required for the communication with the data storage server 3.

The application creation section 105 creates, by use of the application information received by the application information reception section 102, the communication application executing as part of functions based on the function information received by the function information reception section 103 and the communication settings received by the communication setting reception section 104. For example, the application creation section 105 holds a predefined programming tool having a function of communication with the data storage server 3, and sets the function information and communication settings received above in this programming tool to thereby create the communication application described above.

This communication application created by the application creation section 105 is transmitted from the communication section 11 to the image forming apparatus 2 via the Internet or stored into a USB memory from a USB interface, not shown, included in the information processor 1, and the data is transferred to the image forming apparatus 2 via this USB memory.

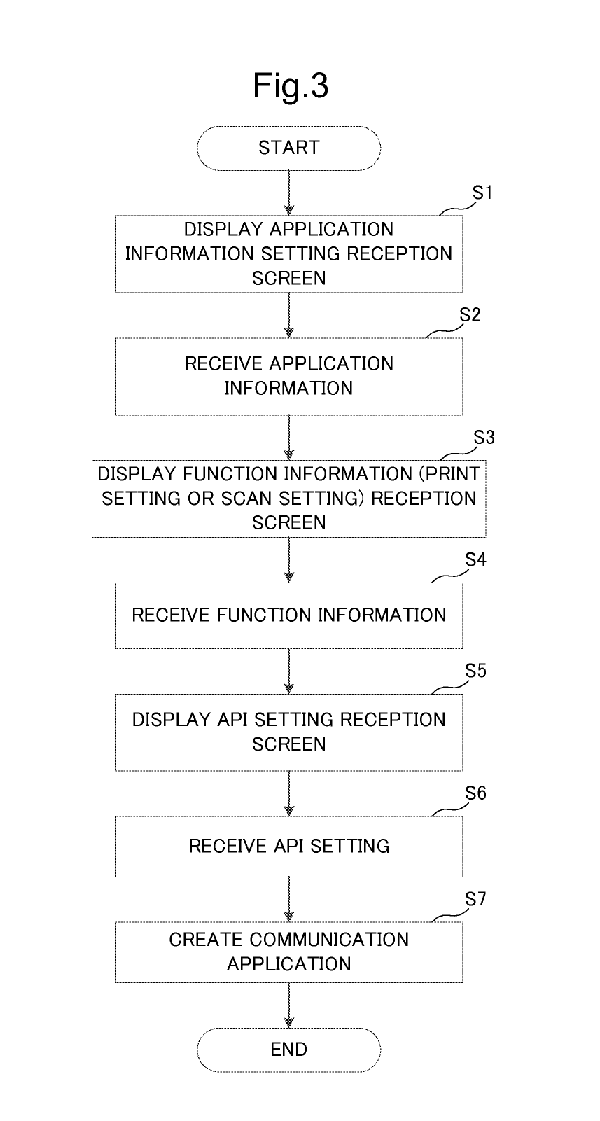

Next, the application creation processing performed by the information processor 1 in which the application creation program is installed will be described. FIG. 3 is a flowchart showing the application creation processing performed by the information processor 1.

First, communication application creation processing performing a series of processing of getting access from the image forming apparatus 2 to the data storage server 3 to download a desired file and then printing the downloaded file in the image forming apparatus 2 will be described.

Moreover, from a file list acquiring URL and a file information acquiring URL to be described later on, a communication module function that permits connection to these URLs and data required for this connection are provided.

The operator operates the operation section 13 of the information processor 1 to input an instruction for communication application creation, upon which the display control section 101 makes the display section 14 display an application information setting reception screen D1 (S1).

When this application information setting reception screen D1 is displayed, the operator operates the operation section 13 to input application information, upon which the application information reception section 102 receives this inputted application information (S2).

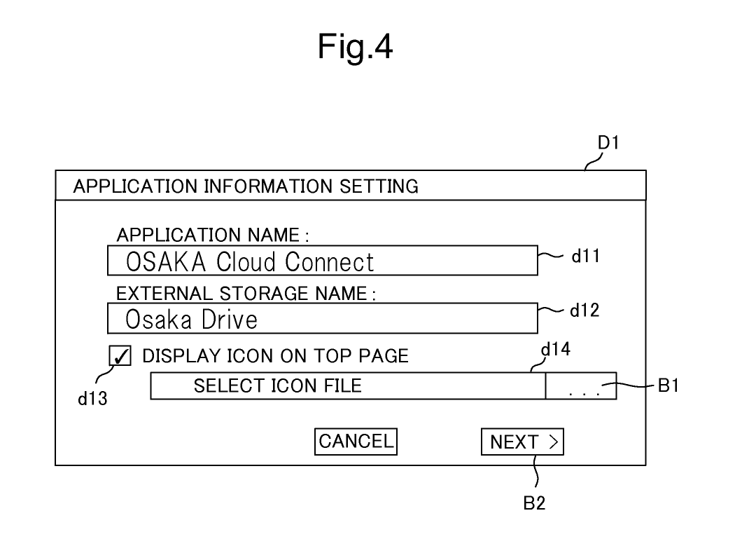

For example, the operator operates the mouse pointer as the operation section 13 to place a cursor at an application name input field d11 of the application information setting reception screen D1 shown in FIG. 4 and input characters such as “OSAKA Cloud Connect” from the keyboard as the operation section 13, upon which these characters are received, as a name of the communication application created in this application creation processing, by the application information reception section 102.

Moreover, the operator operates the mouse pointer to place a cursor position at an external storage name input field d12 of the application information setting reception screen D1 and input, for example, characters such as “Osaka Drive” from the keyboard, upon which these characters are received, as a name of the external storage of the data storage server 3 connected through communication by the communication application created this time, by the application information reception section 102.

In this embodiment, the operator can operate the mouse pointer to place the cursor at an icon setting field d13 of the application information setting reception screen Dl and input an instruction by, for example, left clicking, and further can operate the mouse pointer for a select button B1 of an icon file specification field d14 to specify a desired icon image from among icon images stored in the storage section 12 of the information processor 1.

When the operator specifies a “NEXT” button B2 with the mouse pointer after completing inputting of the application information described above, reception of each application information inputted above is confirmed at the application information reception section 102 (S2).

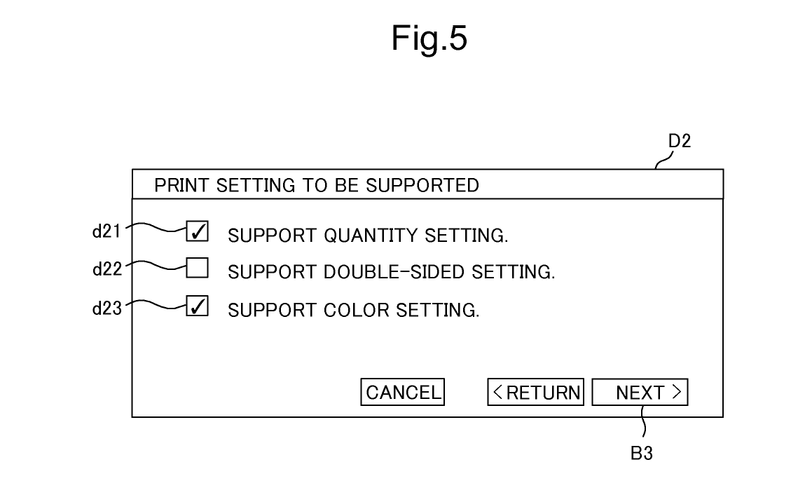

After the reception of the application information described above, the display control section 101 makes the display section 14 display a function information reception screen (S3). For example, the display control section 101 makes the display section 14 display a print setting reception screen D2 shown in FIG. 5 as a function information reception screen.

When this print setting reception screen D2 is displayed, the operator operates the mouse pointer to place the cursor at a quantity setting support input field d21 by, for example, left clicking, upon which an instruction for adding a function of setting a quantity of prints at time of print operation to the created communication application is received by the function information reception section 103. Similarly, the operator operates the mouse pointer to place the cursor at a double-side setting support input field d22 by, for example, left clicking and input an instruction, upon which an instruction for adding, to the created communication application, a function of setting whether or not to perform double-sided printing at time of print operation (an instruction for performing only one-sided printing if this instruction is not to be provided) is received by the function information reception section 103. Moreover, the operator operates the mouse pointer to place the cursor at a color setting support input field d23 and input an instruction by, for example, left clicking, upon which an instruction for adding, to the created communication application, a color printing function at time of print operation (an instruction for performing only black and white printing, if this instruction is not provided) is received by the function information reception section 103.

When the operator specifies a “NEXT” button B3 with the mouse pointer after completing the inputting of the print information described above, the reception of each of the inputted print settings is confirmed at the function information reception section 103 (S4).

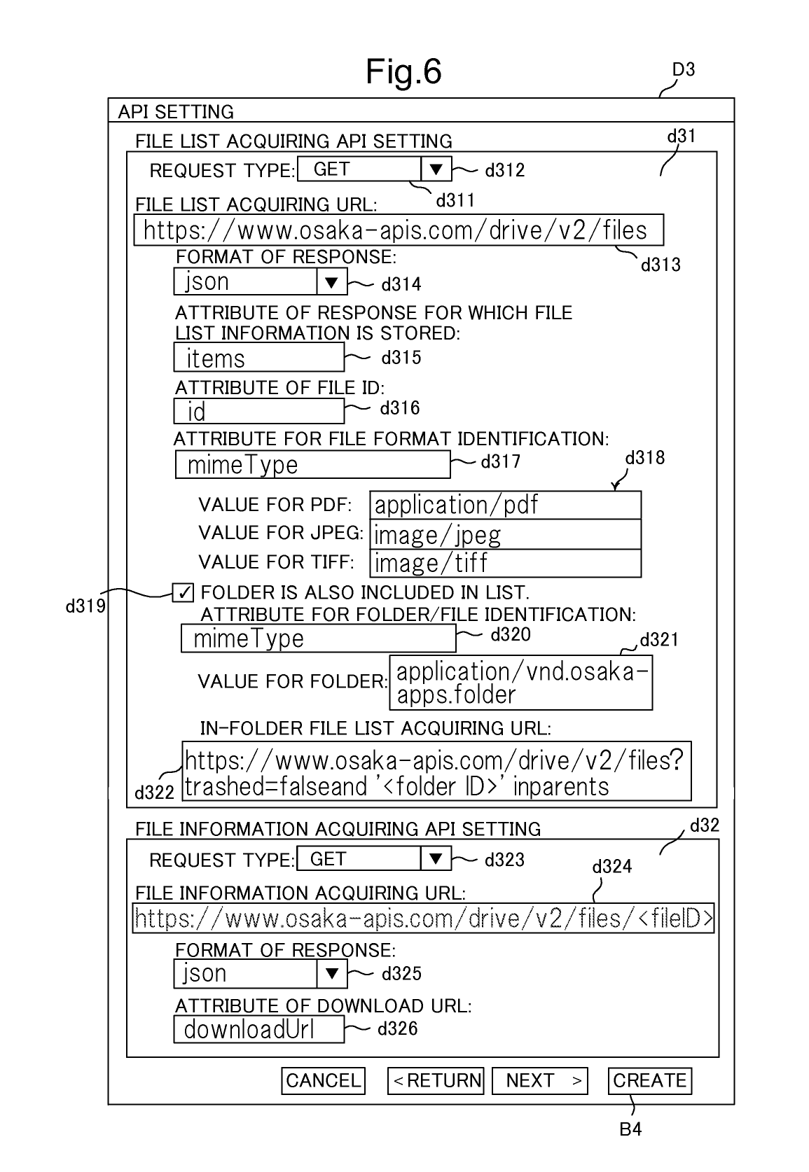

Subsequently, after the reception of the print settings described above, the display control section 101 makes the display section 14 display an API setting reception screen D3 (FIG. 6) for receiving a communication setting (API setting here) required for the communication with the data storage server 3 by the communication setting reception section 104 (S5). The API setting reception screen D3 has: a file list acquiring API setting field d31; and a file information acquiring API setting field d32.

When the API setting reception screen D3 is displayed, at the file list acquiring API setting field d31, the operator operates the mouse pointer to specify a pull-down image section d312 of a request type input field d311, upon which the display control section 101 causes pull-down display of “GET” and “POST”. The operator operates the mouse pointer to thereby specify a desired request type, upon which the specified one of “GET” and “POST” is received as a method of passing over data to a CGI by the communication setting reception section 104.

Moreover, the operator operates the mouse pointer to place the cursor position at a file list acquiring URL input field d313 and input, from the keyboard, a URL of the data storage server 3 which provides a list of files stored in the storage (file list), upon which the file list acquiring URL is received by the communication setting reception section 104. That is, the fact that the provision of the file list as the data required for providing the data storage service described above is received from the file list acquiring URL (URL indicating the data storage server 3) is received.

Moreover, the operator operates the mouse pointer to place the cursor position at a format input field d314 for a response and specify a pull-down image portion by, for example, left clicking, upon which the display control section 101 causes pull-down display of, for example, “json” and “XML-RPC”. The operator operates the mouse pointer to specify a display portion of a desired format, upon which this format is received as the format of the response by the communication setting reception section 104.

Moreover, the operator operates the mouse pointer to place the cursor at an attribute input field d315 for a response for which the file list information is stored and input an attribute of the response for which the file list information is stored, upon which the attribute of the response is received by the communication setting reception section 104.

Moreover, the operator operates the mouse pointer to place the cursor at an attribute input field d316 for a file ID and input an attribute of the file ID from the keyboard, upon which the attribute of this file ID is received by the communication setting reception section 104.

Further, the operator operates the mouse pointer to place the cursor position at an attribute input field d317 for file format identification and input an attribute (for example, mime Type) for the file format identification from the keyboard, upon which the attribute for the file format identification is received by the communication setting reception section 104. For the file format that is desired to be made treatable with this created communication application, at a format input field d318, the operator inputs a value with the mouse pointer and the keyboard, whereby this inputted file format of this value is received as the treatable file format by the communication setting reception section 104.

Moreover, of pieces of data included in the file list described above, for settings for targeting on a folder in addition to the file for downloading, the operator operates the mouse pointer to place the cursor position at a folder setting field d319 and input an instruction by, for example, left clicking. An instruction for targeting on the folder for downloading is inputted and the operator operates the mouse pointer and the keyboard to input an attribute used for identification of the folder and the file is inputted into an identification attribute input field d320, upon which the attribute is received by the communication setting reception section 104. The operator operates the mouse pointer and the keyboard to input a value for the folder at an input field d321, upon which this value is received by the communication setting reception section 104.

Moreover, the operator operates the mouse pointer to place the cursor at an in-folder file list acquiring URL input field d322 and input, from the keyboard, a URL of the data storage server 3 which URL provides an in-folder file list, upon which this inputted in-folder file list acquiring URL is received by the communication setting reception section 104. The input operation of the file list acquiring URL is an operation of specifying an API for also receiving the provision of the in-folder file list from the in-folder file list acquiring URL (URL managed by the data storage server 3).

When the API setting reception screen D3 is displayed, at the file information acquiring API setting field d32, the request type inputting for acquiring the file list described above applies, and at a request type input field d323, either one of “GET” and “POST”, which is specified by the operator, is received by the communication setting reception section 104.

The operator operates the mouse pointer to place the cursor at a file information acquiring URL input field d324 and input, from the keyboard, a URL of the data storage server 3 which URL provides the file information, upon which this inputted file information acquiring URL is received by the communication setting reception section 104.

At a format input field d325 for a response, as is the case with the one for acquiring the file list described above, an input of a format of the response for file information acquisition is received by the communication setting reception section 104.

The operator operates the mouse pointer to place the cursor at an attribute input field d326 for a download URL and input an attribute of the download URL from the keyboard, upon which the inputted attribute of the download URL is received by the communication setting reception section 104.

When the operator specifies a “CREATE” button B4 with the mouse pointer after completing the inputting of the API settings described above, the reception of each API setting inputted above is confirmed at the communication setting reception section 104 (S6).

As described above, upon the reception of the application information, the print settings, and the API settings, the application creation section 105 sets the print settings and API settings described above in the aforementioned programming tool, and creates a communication application which operates in accordance with these print settings and API settings and which is accompanied by the application information received above (S7). At this point, the application creation section 105 installs a program, which performs display of folder and file lists indicated by the file list received from the aforementioned URL indicated by the API and printing of the file (document) received from this URL, to thereby create the communication application.

According to this embodiment, thanks to, for example, a program development technology using an API, to create a communication application which can execute a communication function required for communication between the data storage server 3 providing the data storage service on the web and the image forming apparatus 2 as a client terminal and processing related to handling of print target data as data targeted for communication before and after this communication, the developer himself or herself is no longer required to implement, on this communication application, a communication module required for the image forming apparatus 2 to communicate with the data storage server 3 and a program for executing print operation on the print target data acquired after the communication. As a result, upon development of such a communication application, the developer is no longer required to have technical knowledge for implementing the communication module and program, thus reducing technical and temporal loads on the developer, which makes it possible to even more efficiently develop the communication application.

For example, there are many cloud services which provide the data storage service on the web, and with the program development technology using the API described above, a creation program for creating an application which communicates with this data storage has been suggested. However, even with such a creation program, a communication module required to communicate between the image processor in which the application is installed and the cloud service described above needs to be implemented in the application by the developer. Thus, there are demands on the developer for technical knowledge for performing this implementation, and it takes time for the application development. Moreover, it is also required to efficiently develop an application which not only simply makes communication with the data storage described above but is also provided with a program for processing related to handling of data targeted for communication before and after the communication.

However, as described above, this embodiment makes it possible to develop, more efficiently than a conventional case, an application which permits performing data communication with the server on the web providing the data storage service and executing processing related to data handling before and after this communication.

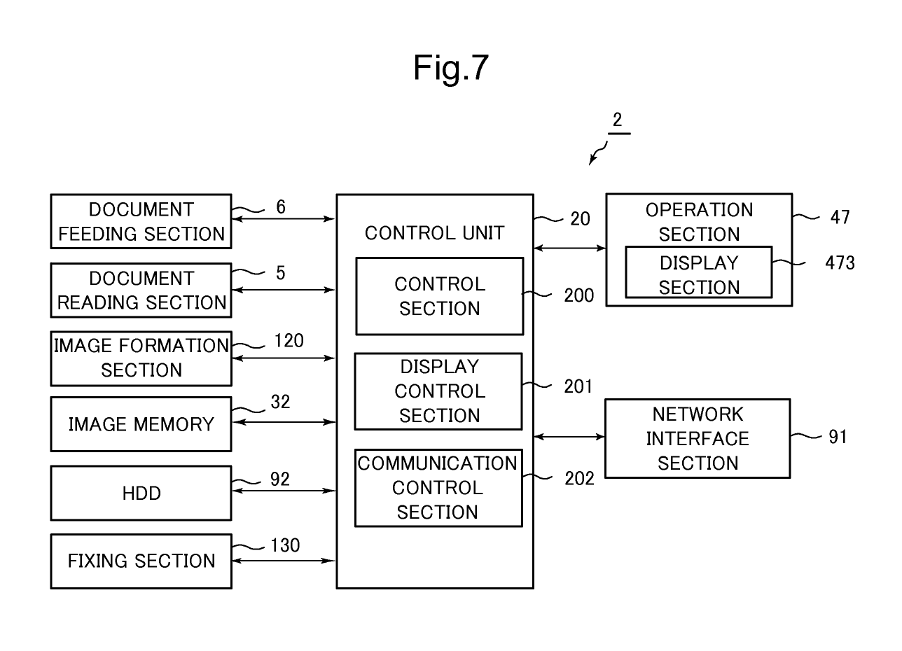

Next, communication and print operation based on the communication application created as described above will be described. First, configuration of the image forming apparatus 2 in which this communication application is installed will be described. FIG. 7 is a block diagram showing electrical configuration of the image forming apparatus 2.

The communication application created above is installed in the image forming apparatus 2. The image forming apparatus 2 includes: a control unit 20, an operation section 47, a document feeding section 6, a document reading section 5, an image memory 32, an image formation section 120, a fixing section 130 a network interface section 91, an HDD 92, etc.

The document reading section (data acquisition section) 5 includes a reading mechanism having a light irradiation section, a CCD sensor, etc. under control by the control unit 20. The document reading section 5 irradiates a document by the light irradiation section and receives reflective light thereof with the CCD sensor to thereby read an image from the document.

The image memory 32 is a region which temporarily stores data of an image of a document acquired through reading by the document reading section 5 and temporarily saves print target data of the image formation section 120.

The network interface section 91 is composed of a communication module such as a LAN board, and performs data communication in connection with a server providing a data storage service on the web or a server providing an API via the Internet connected to the network interface section 91.

The HDD 92 is a large-capacity storage device which stores, for example, the image of the document read by the document reading section 5.

The control unit 20 is composed of: a CPU (Central Processing Unit), a RAM, a ROM, a dedicated hardware circuit, etc., and is responsible for overall operation control of the image forming apparatus 2. The control unit 20 includes a control section 200, a display control section 201, and a communication control section 202.

The control section 200 is connected to the operation section 47, the document feeding section 6, the document reading section 5, the image memory 32, the image formation section 120, the fixing section 130, the network interface section 91, the HDD 92, etc., and performs control of these sections.

A communication application is stored in the HDD 92 or the ROM described above, and the control unit 20 operates in accordance with this communication application to thereby function as the control section 200, the display control section 201, and the communication control section 202. Note that, without depending on the communication application, the control unit 20 may include the control section 200, the display control section 201, and the communication control section 202 as a hardware circuit.

The display control section 201 makes the display section 473 display various operation screens for use in operation performed upon communication and printing based on the communication application.

The communication control section 202 executes various controls required for communication based on the communication application.

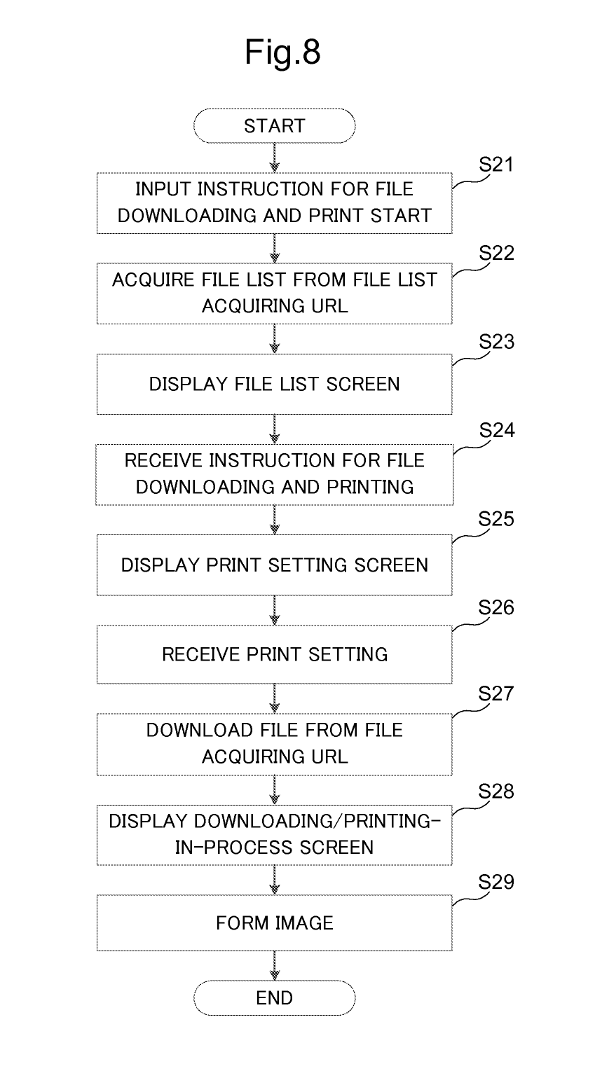

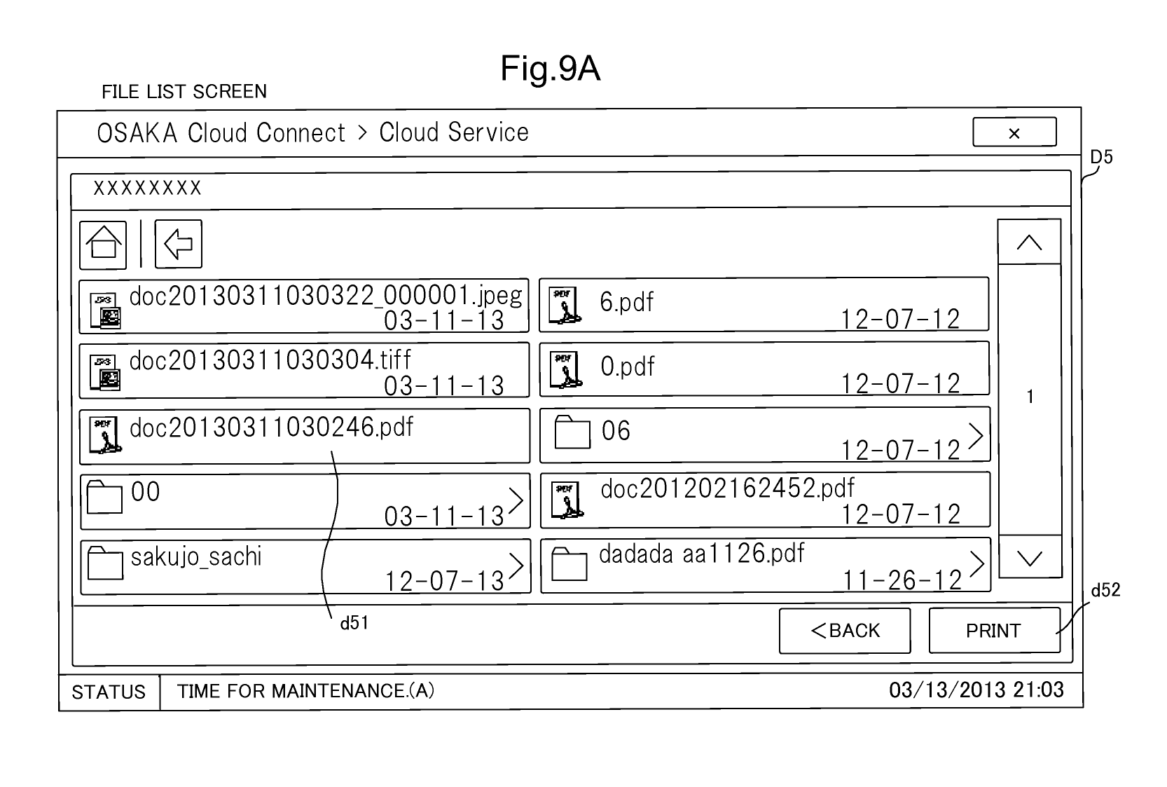

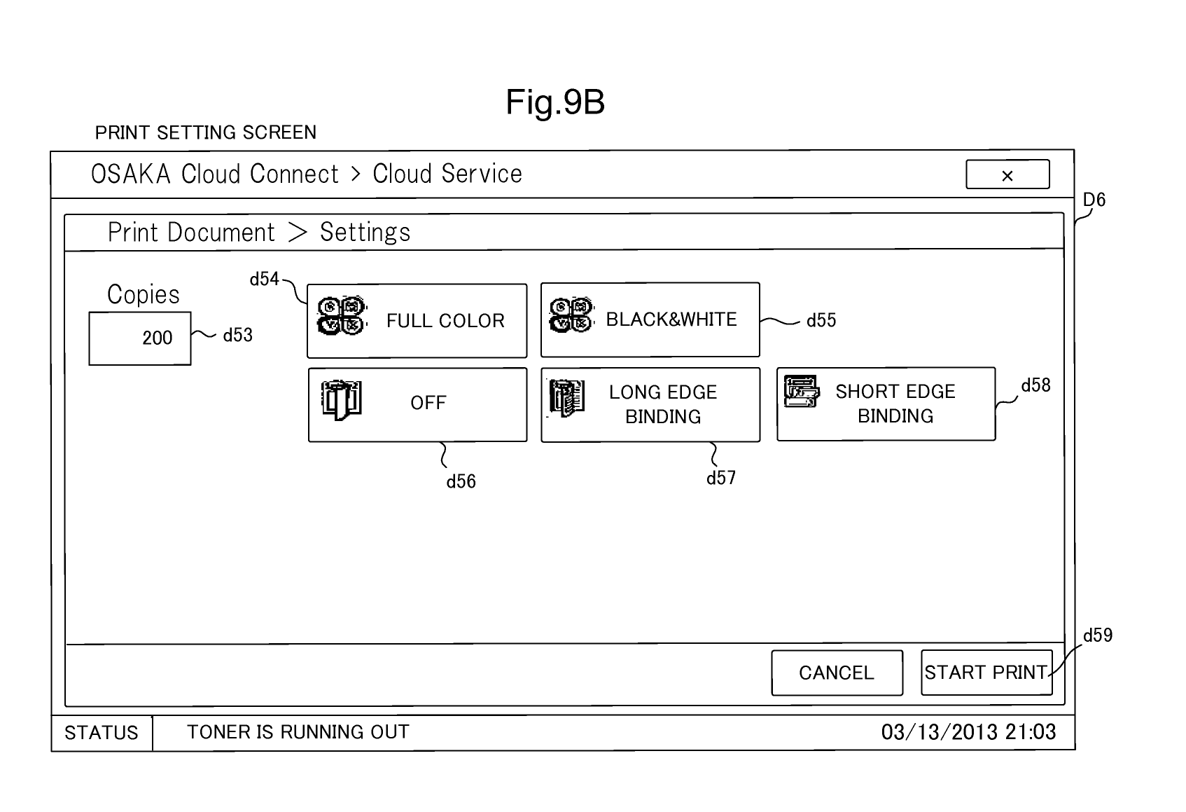

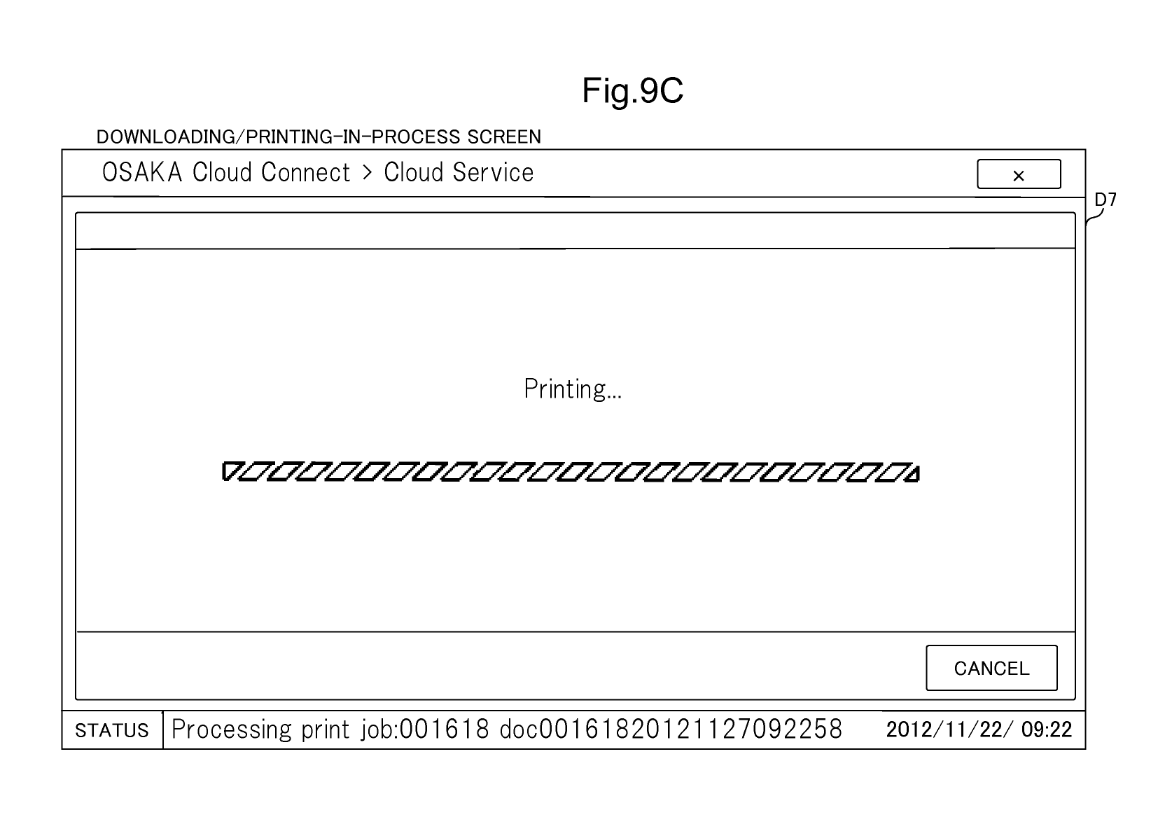

Next, a series of processing of file downloading and printing performed in the image forming apparatus 2 based on the communication application will be described. FIG. 8 is a flowchart showing the series of processing of file downloading and printing performed in the image forming apparatus 2. FIGS. 9A, 9B, and 9C are each one example of an operation screen.

Through operation of the operation section 47 by the operator, start instructions for downloading a file (document) from the data storage server 3 and executing printing of this downloaded file are inputted (S21), upon which the communication control section 202 gets access to the aforementioned file list acquiring URL installed in the communication application, receives a communication module function provided by this URL to communicate with this URL, and then acquire a file list from this URL (S22). The display control section 201 makes the display section 473 display a file list screen D5 shown in the example of FIG. 9A (S23).

When this file list screen D5 is displayed, the operator operates the operation section 47 to contact, with his or her finger, a display portion of an image indicated by the file to be downloaded and printed, for example, an image d51, from among images indicated by the displayed file, and further contact, with his or her finger, a print key d52, upon which an instruction for downloading and printing the file indicated by the image d51 is received through a touch panel included in the display section 473 (S24).

Subsequently, the display control section 201 makes the display section 473 display a print setting screen D6 (see FIG. 9B) for receiving print settings such as color/black and white, double-sided/one-sided, and a quantity of prints (S25).

When this print setting screen D6 is displayed, the operator inputs values indicating color/black and white, double-sided/one-sided, and a quantity of prints through contact with image portions d53 to d58 displaying desired items, for example, the color/black and white, the double-sided/one-sided, and the quantity of prints or ten key operation, and further contacts with a print start key d59, upon which the print settings indicating these inputted values are received by the control section 200 (S26).

In accordance with this print start key d59, the communication control section 202 gets access to the file information acquiring URL installed in the communication application, receives the communication module function provided by this URL, and downloads the file specified in S24 from this file information acquiring URL (S27). When this download processing is started, the display control section 201 makes the display section 473 display a downloading/printing-in-process screen D7 (see FIG. 9C) indicating that downloading and printings are being executed (S28).

Then the control section 200 causes the image formation section 120 to perform image formation (printing) of the downloaded file as print target data (S29). After end of this image formation, the display control section 201 ends the display of the downloading/printing-in-process screen D7 at the display section 473.

As described above, upon the installation of the communication application, which has been created in the information processor 1 based on the aforementioned application creation program, into the image forming apparatus 2 through operation based on the communication application, the operator can cause the image forming apparatus 2 to perform the series of operation of receiving the communication module provided from the file list information acquiring URL and the file information acquiring URL, downloading a desired file from the data storage server 3 on the web, and printing this downloaded file through easy operation only including operation of specifying the file targeted for downloading as described above and operation of inputting print settings for printing of the downloaded file.

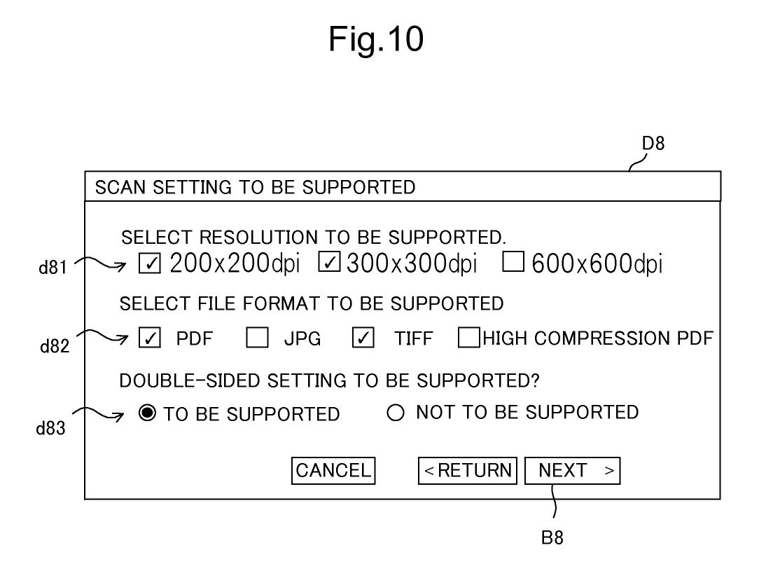

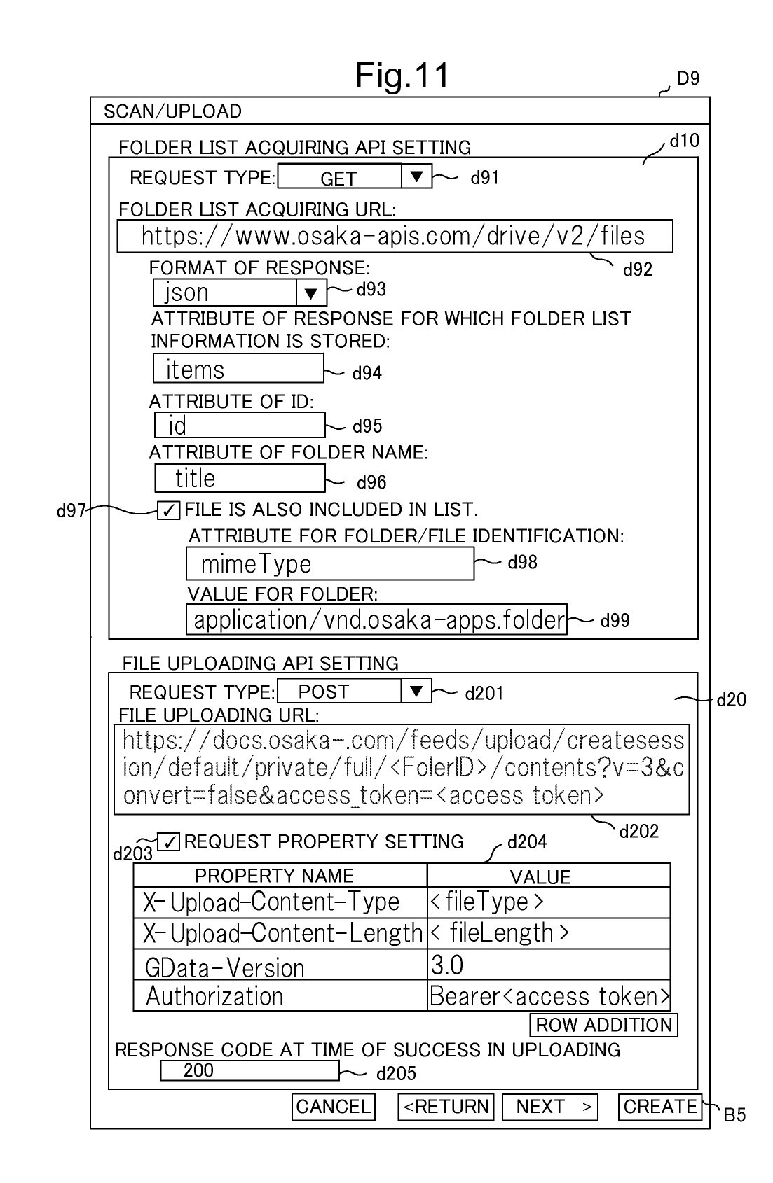

Next, the application creation processing performed by the information processor 1 in which the application creation program is installed, i.e. processing of creating a communication application for performing scan operation performed in the image forming apparatus 2 and a series of processing of uploading the data obtained through this scan operation will be described with reference to the flowchart shown in FIG. 3 referred above and FIG. 4, and also to FIGS. 10 and 11. The same processing as the processing already described in the processing of creating the communication program for performing the file downloading and printing described above will be omitted from the description.

The operator operates the operation section 13 of the information processor 1 to input an instruction for creating a communication application, upon which the display control section 101 makes the display section 14 display the application information setting reception screen Dl (FIG. 4) (S1).

When this application information setting reception screen Dl is displayed, based on the operation of the operation section 13 by the operator, application information is received by the application information reception section 102 (S2).

After the reception of the application information described above, the display control section 101 makes the display section 14 display a scan setting reception screen D8 illustrated in an example of FIG. 10 (S3).

When this scan setting reception screen D8 is displayed, the function information reception section 103 receives, as function information, setting items related to the scan operation, for example, resolution for the scan operation, a file format upon file creation of a scanned image, and whether double-sided scan or one-sided scan is to be performed.

For example, when the scan setting reception screen D8 is displayed, the operator operates the mouse pointer to place the cursor at a support resolution input field d81 and input an instruction by, for example, left clicking, upon which resolution indicated by the cursor position is specified and this resolution is received by the function information reception section 103. Moreover, the operator operates the mouse pointer to place the cursor at a support file format input field d82 and input an instruction by, for example, left clicking, upon which a file format indicated by the cursor position is specified and this file format is received by the function information reception section 103. Moreover, the operator operates the mouse pointer to place the cursor at a double-sided setting input field d83 and input an instruction by, for example, left clicking, upon which a double-sided or one-sided setting indicated by the cursor position is specified and this double-sided or one-sided setting is received by the function information reception section 103. When the operator specifies, with the mouse pointer, a “NEXT” button B8 after completing the inputting of API settings described above, reception of each of the inputted scan settings described above is confirmed at the function information reception section 103 (S4).

After the reception of the scan settings described above, the display control section 101 makes the display section 14 display an API setting reception screen D9 for scan uploading shown in an example of FIG. 11 (S5).

The API setting reception screen D9 has: a folder list acquiring API setting field d10; and a file uploading API setting field d20.

When the API setting reception screen D9 is displayed, at the folder list acquiring API setting field d10, based on operation of the mouse pointer by the operator, a desired request type can be specified at a request type input field d91, and the specified request type is received by the communication setting reception section 104.

Moreover, the operator operates the mouse pointer to place the cursor at a folder list acquiring URL input field d92 and input an URL of the data storage server 3 which URL provides a folder list from the keyboard, upon which this inputted folder list acquiring URL is received by the communication setting reception section 104. That is, operation of inputting the folder list acquiring URL is operation of specifying an API for receiving folder list provision from the folder list acquiring URL (URL managed by the data storage server 3).

Moreover, the operator operates the mouse pointer to place the cursor at a format input field d93 for a response and specify a desired format (for example, json) by, for example, left clicking, upon which the format specified as the format of the response is received by the communication setting reception section 104.

Moreover, the operator operates the mouse pointer to place the cursor at an attribute input field d94 for a response for which folder list information is stored and input, from the keyboard, attributes (for example, items) of the response for which the file list information is stored, upon which the attributes of this response are received by the communication setting reception section 104.

Moreover, the operator operates the mouse pointer to place the cursor at an attribute input field d95 for an ID and input an attribute (for example, id) for the ID from the keyboard, upon which the attribute of this ID is received by the communication setting reception section 104.

Moreover, the operator operates the mouse pointer to place the cursor at an attribute input field d96 for a folder name and input an attribute of the folder name from the keyboard, upon which the attribute of this folder is received by the communication setting reception section 104.

Moreover, of the data shown in the file list described above, for a setting for whether or not a file is also targeted for downloading, the operator operates the mouse pointer to place the cursor at a file setting field d97 and input an instruction by, for example, left clicking. If the instruction for providing the file as a downloading target is inputted, the operator operates the operation section 13 to thereby input an attribute (for example, mimeType) used for folder and file identification, upon which the attribute is received by the communication setting reception section 104. Moreover, through the operation of the operation section 13, the operator inputs a value for the folder at a value input field d99, upon which this value is received as the value for the folder by the communication setting reception section 104.

Further, at a file uploading API setting field d20, the operator can operate the mouse pointer to place the cursor at a request type input field d201 by, for example, right clicking and thereby specify a desired request type, and the specified request type (for example, POST) is received by the communication setting reception section 104.

Moreover, the operator operates the mouse pointer to place the cursor position at a file uploading URL input field d202 and input, from the keyboard, the URL of the data storage server 3 which URL provides a file upload service, upon which this inputted file uploading URL is received by the communication setting reception section 104. That is, operation of inputting the file uploading URL is operation of specifying an API for performing folder uploading on the folder list acquiring URL (URL managed by the data storage server 3).

Moreover, the operator operates the mouse pointer to place the cursor at a setting input field d203 for request property and input an instruction for setting the request property by, for example, right clicking, and then operates the mouse pointer to place the cursor at a name and value input field d204 for the request property and input a pair of a name and a value of the request property from the keyboard, upon which the name and the value of the request property are received by the communication setting reception section 104.

Moreover, the operator operates the mouse pointer to place the cursor at a response code input field d205 at time of success in uploading and input a desired code from the keyboard, upon which this code is received as a response code by the communication setting reception section 104.

When the operator specifies a “CREATE” button B5 with the mouse pointer after completing the inputting of each API setting described above, the reception of each API setting inputted above is confirmed at the communication setting reception section 104 (S6).

As described above, upon reception of the application information, the scan settings, and the API settings, the application creation section 105 sets these received scan settings and API settings in the programming tool described above to create a communication application which operates in accordance with these scan settings and API settings together with the application information received above (S7). At this point, the application creation section 105 installs a program for performing display of folders and files indicated by the folder list received from the aforementioned URL indicated by this API, scanning operation by the document reading section 5, and outputting of the file composed of image data acquired through this scan operation to the communication module, and then creates this communication application.

According to this embodiment, thanks to, for example, a technology of program development using an API, to create a communication application which can execute a communication function required for the image forming apparatus 2 as a client terminal to make communication with the data storage server 3 providing the data storage service on the web and processing related to handling of the data acquired through the scan operation as data targeted for the communication before and after this communication, in order for the image forming apparatus 2 to make communication with the data storage server 3, the communication module required for the image forming apparatus 2 to make communication with the data storage server 3 and the program for executing the scan operation performed before the communication are no longer required to be implemented in the communication application by the developer himself or herself. As a result, upon development of such a communication application, the developer is no longer required to have technical knowledge for implementing this communication application and the program, thus reducing technical loads and temporal loads on the developer, which makes it possible to even more efficiently develop the communication application.

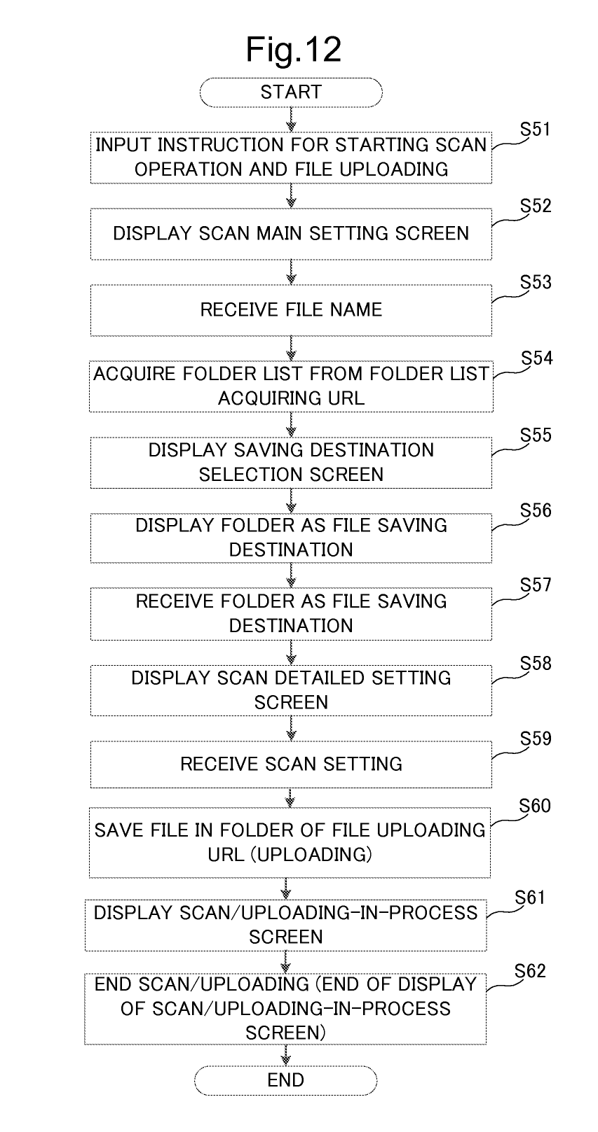

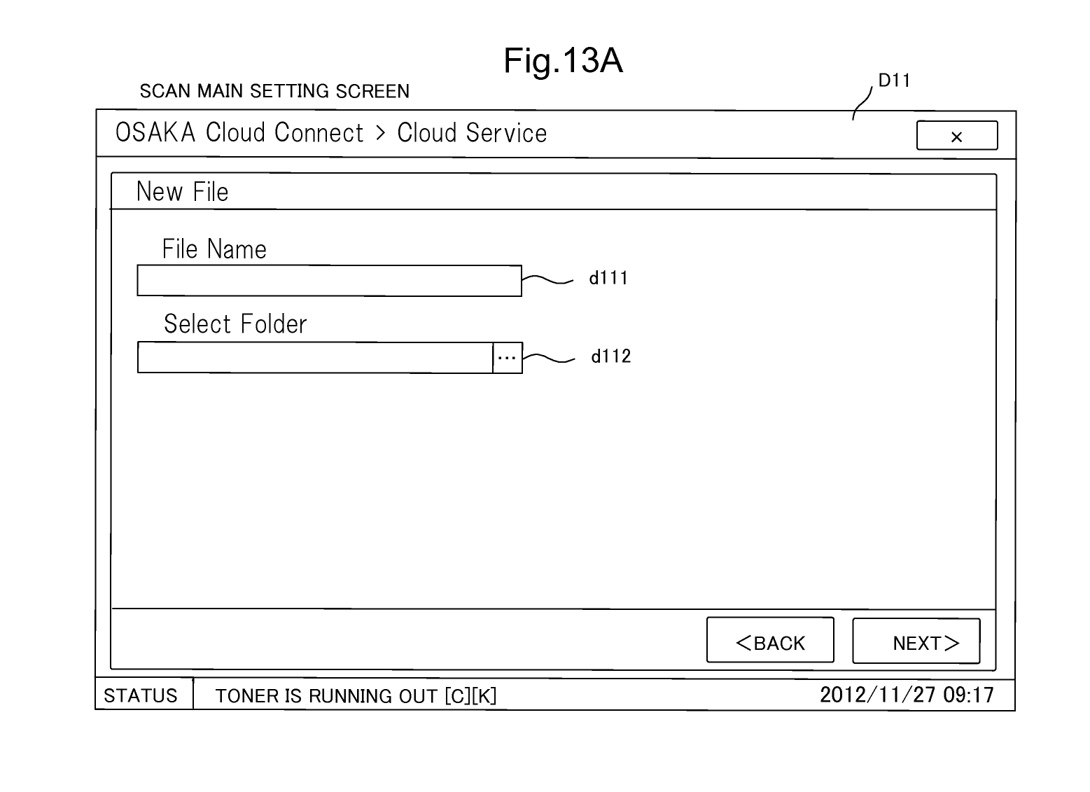

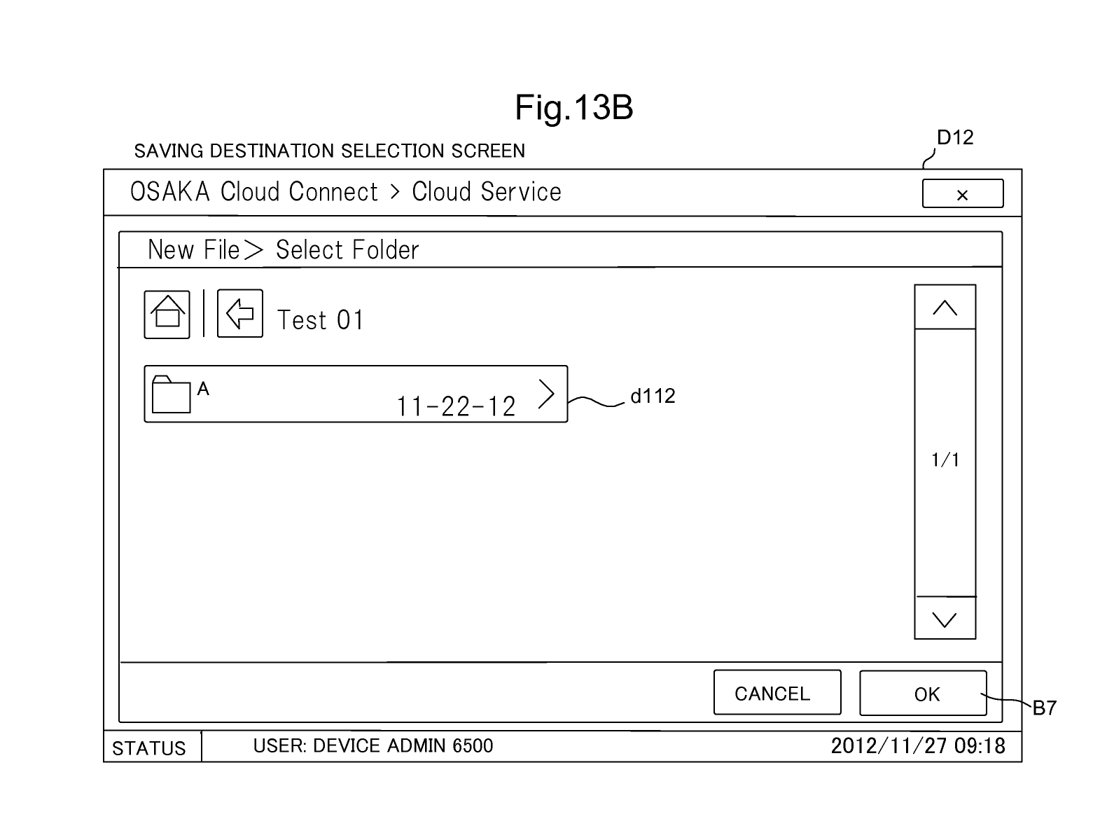

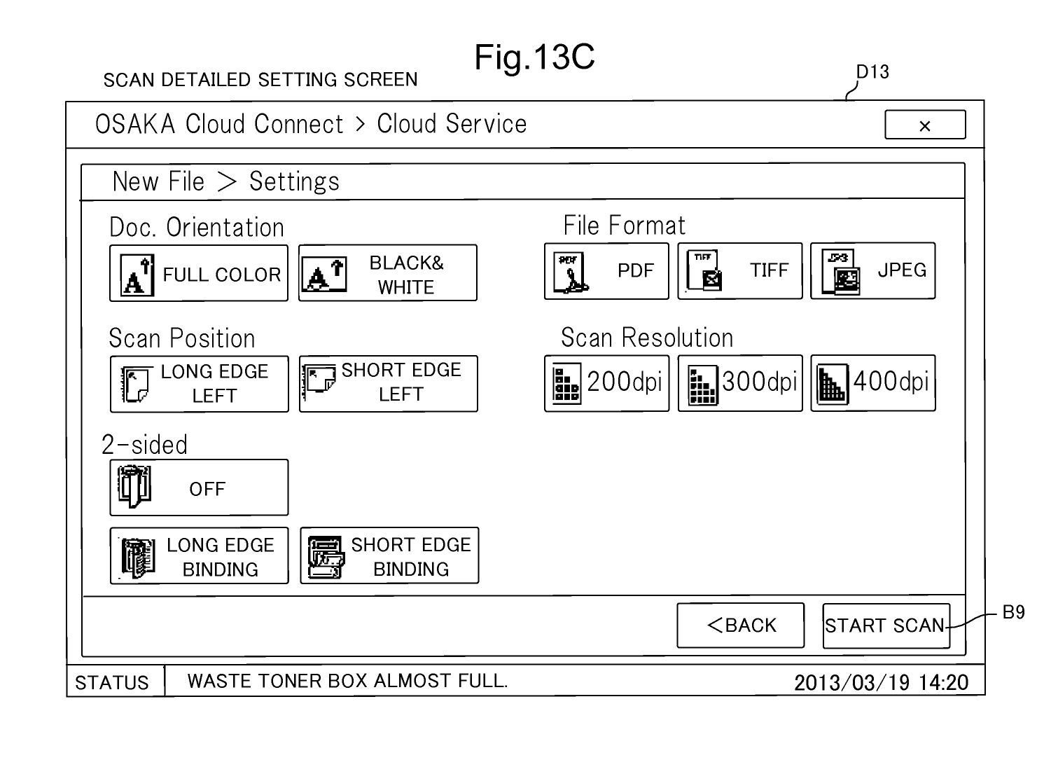

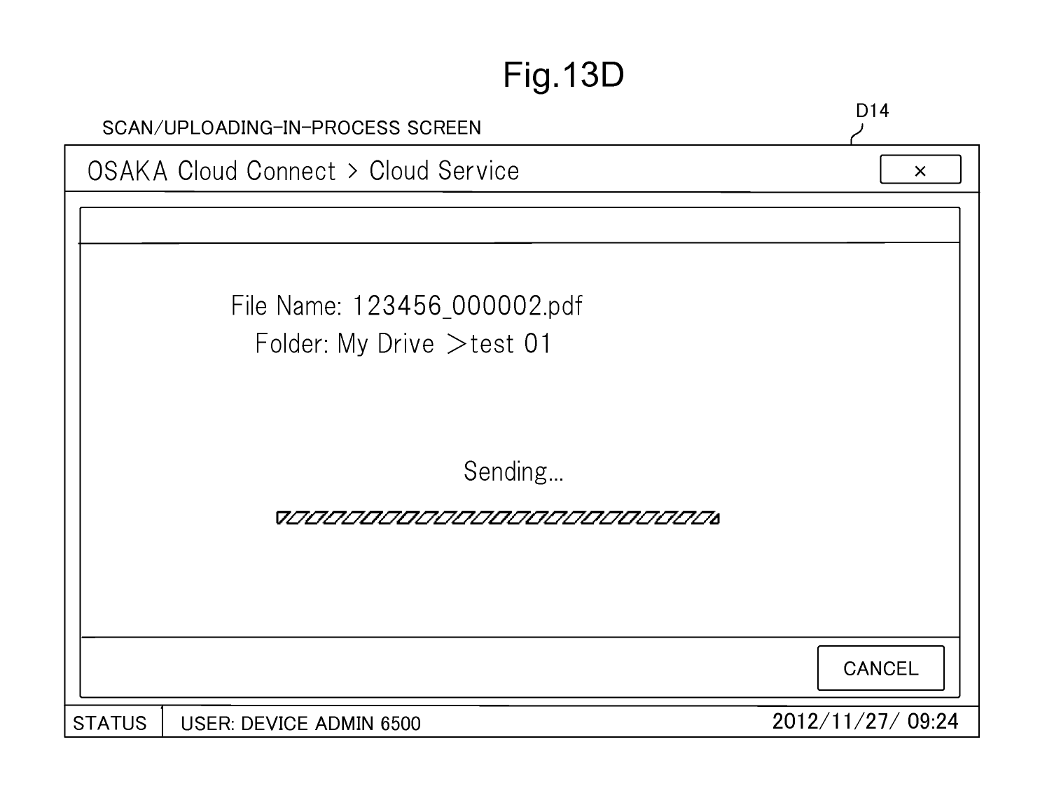

Next, the series of processing including the scan operation performed in the image forming apparatus 2 based on the communication application and the uploading of the file acquired through this scan operation will be described. FIG. 12 is a flowchart showing the series of processing including the scan operation performed in the image forming apparatus 2 and the uploading of the file acquired through this scan operation. FIGS. 13A, 13B, 13C, and 13D are each example of an operation screen.

Through operation of the operation section 47 by the operator, an instruction for starting execution of the scan operation and the uploading of a file acquired through this scan operation is inputted (S51), upon which the display control section 201 makes the display section 473 display a scan main setting screen D11 (see FIG. 13A) for receiving a name of the file acquired through the scan operation and a destination folder of this file (S52).

On this scan main setting screen D11, the operator makes contact with a file name input field dill, upon which, for example, a soft keyboard image is displayed on the display screen, and the operator operates this soft keyboard screen, upon which a file name is inputted by the touch panel, and the inputted name is received as a name of the file created through scanning by the communication control section 202 (S53).

The operator operates a saving destination folder input field d112, upon which the communication control section 202 gets access to the folder list acquiring URL described above, receives a communication module function provided by this URL to communicate with this URL, and acquires a folder list from this URL (S54). The display control section 101 causes transition of screen display from the scan main setting screen D11 to a saving destination selection screen D12 shown in FIG. 13B (S55). The operator operates the mouse pointer to place the cursor at a saving destination input field d121 on the saving destination selection screen D12, upon which the display control section 201 pull-down displays each folder as a file saving destination shown in the folder list acquired above (S56). At this pull-down display portion, the operator contacts and selects a display section of the folder as the saving destination through the touch panel and contacts an “OK” button B7, upon which this selected folder is received as an uploading destination of the file acquired through the scan operation, that is, a destination folder of this file by the communication control section 202 (S57).

Subsequently, the display control section 201 makes the display section 473 display a scan detailed setting screen D13 for receiving inputs of various settings for scan operation, for example, set items including orientation of a document to be read, a scan position, double sided/one-sided, file format, and resolution (S58). When this scan detailed setting screen D13 is displayed, the operator makes contact with an image portion displaying the desired setting item or ten key operation to thereby input values indicating the orientation of the document to be read, the scan position, the double-sided/one-sided, the file format, and the resolution, upon which each of the scan settings is received by the control section 200 (S59).

Here, the operator makes contact with a scan start button B9, upon which the control section 200 causes the document reading section 5 to perform operation (scan operation) of reading a document loaded on a document reading stand of an automatic feeding mechanism or contact glass of a flatbed to create a file composed of image data acquired through this scanning.

Subsequently, the communication control section 202 gets access to the file uploading URL, receives a communication function provided from this URL, and saves a file acquired through the scan operation described above into the folder received in S57 described above which is included in those held by the data storage of this URL (S60). That is, the communication control section 202 uploads the file acquired through the scan operation described above into the folder held in the data storage of the file uploading URL.

When the scan operation and uploading processing described above start, the display control section 201 makes the display section 473 display a scan/uploading-in process screen D14 indicating that the processing is in execution (S61).

Then after end of the uploading, the display control section 201 ends the display of the scan/uploading-in-process screen D14 at the display section 473 (S62).

As described above, upon the installation of the communication application created above into the image forming apparatus 2, through operation based on the communication application, the operator can perform the scan operation in the image forming apparatus 2 and the uploading of the file acquired through the scanning into the data storage by means of easy operation.

This disclosure is not limited to the configuration of the embodiment described above, and various modifications thereto can also be made. For example, in the embodiment described above, an image forming apparatus is used as one embodiment according to this disclosure but this is only one example, and thus any of other electronic devices, for example, a printer, a copier, and a facsimile device may be used.

Moreover, in the embodiment described above, the configuration and the processing indicated by the embodiment described above with reference to FIGS. 1 through 13 are each only one embodiment of this disclosure, and this disclosure is not limited to these configuration and processing. For example, the application creation program for creating the communication application may be contained in the data storage server 3 and the communication application may be able to be created by the data storage server 3.

Various modifications and alterations of this disclosure will be apparent to those skilled in the art without departing from the scope and spirit of this disclosure, and it should be understood that this disclosure is not limited to the illustrative embodiments set forth herein.

What is claimed is:

1. An information processor creating a communication application for connecting a client terminal via a network to a server providing a data storage service and causing data communication between the client terminal and the server, the information processor comprising:
an application information reception section receiving an input of application information accompanying the communication application;
a function information reception section receiving an input of function information indicating a function included in predefined processing performed on data targeted for communication with the server;
a communication setting reception section receiving an input of communication settings, including an URL of the server, required for the communication with the server; and
an application creation section creating, by using the application information received by the application information reception section, the communication application for executing, as part of a function, operation based on the function information received by the function information reception section and the communication settings received by the communication setting reception section.

2. The information processor according to claim 1,
wherein the application creation section creates the communication application as the communication settings by using an API setting received by the communication setting section.

3. The information processor according to claim 1,
wherein the functional information reception section receives a set item related to print operation as the function information, and
the application creation section creates the communication application having a function of causing the client terminal to make communication with the server to download data from the server and print the data.

4. The information processor according to claim 1,
wherein the function information reception section receives a set item related to scan operation as the function information, and
the application creation section creates the communication application having a function of causing the client terminal to perform scan operation in the client terminal and upload data acquired through the scan operation to the server.

5. A computer-readable non-transitory recording medium storing an application creation program for creating a communication application,
wherein the application creation program creates a communication application for connecting a client terminal via a network to a server providing a data storage service and causing the client terminal to perform data communication with the server, and
the application creation program operates the computer as:
an application information reception section receiving an input of application information accompanying the communication application;
a function information reception section receiving an input of function information indicating a function included in predefined processing performed on data targeted for the communication with the server;
a communication setting reception section receiving an input of communication settings, including an URL of the server, required for the communication with the server; and
an application creation section creating, by using the application information received by the application information reception section, the communication application for executing, as part of the function, operation based on the function information received by the function information reception section and the communication settings received by the communication setting reception section.
